(19) United States
(12) Patent Application Publication
(10) Pub. No.: US 2022/0291417 A1
(43) Pub. Date: Sep. 15, 2022

(54) HYDROCARBON WELL PERFORMANCE DECLINE CURVE AND EVALUATION TOOL

(71) Applicant: Saudi Arabian Oil Company, Dhahran (SA)

(72) Inventors: Mohammed K. Mugharbil, Abqaiq (SA); Jawad Zahur, Abqaiq (SA); Ayedh M. Al-Shehri, Abqaiq (SA)

(73) Assignee: Saudi Arabian Oil Company, Dhahran (SA)

(21) Appl. No.: 17/192,367

(22) Filed: Mar. 4, 2021

(51) Int. Cl. G01V 11/00; G01V 99/00; E21B 49/08; G06Q 10/06; G06Q 50/02

(52) U.S. Cl. CPC G01V 11/002; G01V 99/005; E21B 49/087; G06Q 10/0639; G06Q 50/02; G06Q 10/06375; E21B 2200/20; G06N 5/04

(57) ABSTRACT

Systems and methods include a computer-implemented method for selecting well candidates. Pre- and post-stimulation production rates are determined for initial stimulation job candidates of an oil well. A field performance decline factor is determined as an average slope of post-job monthly rate changes for each well determined using a performance decline equation. A time period that a stimulated well will reach its pre-stimulation oil production rate is determined. The performance decline equation is re-executed until a future additional production rate gain approaches zero. A monthly additional production rate is determined based on the field performance decline factor, and a cumulative additional production rate for each candidate is determined. A best candidate is determined based on comparing the cumulative additional production rate for each candidate. The best candidate has a cumulative additional production rate above a pre-determined threshold and greater than cumulative additional production rates of other candidates.

### BACKGROUND

### Technical Field

The present disclosure applies to developing hydrocarbon wells, and more particularly, to losses of production over time.

### Background

A well typically includes a wellbore (or a “borehole”) that is drilled into the earth to provide access to a geologic formation that resides below the earth's surface (or a “subsurface formation”). A well may facilitate the extraction of natural resources, such as hydrocarbons and water, from a subsurface formation, facilitate the injection of substances into the subsurface formation, or facilitate the evaluation and monitoring of the subsurface formation. In the petroleum industry, hydrocarbon wells are often drilled to extract (or “produce”) hydrocarbons, such as oil and gas, from subsurface formations.

Developing a hydrocarbon well for production typically involves a drilling stage, a completion stage, and a production stage. The drilling stage involves drilling a wellbore into a portion of the formation that is expected to contain hydrocarbons (often referred to as a “hydrocarbon reservoir” or a “reservoir”). The drilling process is often facilitated by a drilling rig that facilitates a variety of drilling operations, such as operating a drill bit to cut the wellbore. The completion stage involves operations for making the well ready to produce hydrocarbons, such as installing casing, installing production tubing, installing valves for regulating production flow, or pumping substances into the well to fracture, clean, or otherwise prepare the well and reservoir to produce hydrocarbons. The production stage involves producing hydrocarbons from the reservoir by way of the well. Over time, a well will typically experience a loss in production.

### SUMMARY

The present disclosure describes techniques for using a hydrocarbon well performance decline curve as an evaluation tool for production loss. In some implementations, a computer-implemented method includes the following. Pre- and post-stimulation production rates are determined for initial stimulation job candidates of an oil well. A field performance decline factor is determined as an average slope of post job monthly rate changes for each well determined based on execution of the performance decline equation. A time period that a stimulated well will reach its pre-stimulation oil production rate is determined using the performance decline equation and the pre- and post-stimulation production rates. The performance decline equation is re-executed until a future additional production rate gain approaches zero. A monthly additional production rate is determined using the performance decline equation and based on the field performance decline factor. A cumulative additional production rate for each candidate is determined using the monthly additional production rate. A best candidate is determined based on comparing the cumulative additional production rate for each candidate. The best candidate has a cumulative additional production rate above a pre-determined threshold and greater than cumulative additional production rates of other candidates.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. The techniques can be used to improve the processes for stimulation candidate selection and post job performance evaluation. The performance decline curve estimation tool can be prepared to perform comparative rate and cost analysis. This can enable the user to see stimulation job candidates comparatively rather than standalone. This practice can enhance cost savings and candidate evaluation, including saving time during the evaluation of well for acid stimulation. Post job results can be compared for the amounts of dollars spent for all candidates, which can provide a change of cost savings and improve maximum outcomes cumulative oil production and a total gain in monetary value.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a graph showing examples of plots of monthly production rates for five wells, according to some implementations of the present disclosure.

FIG. 2 is a flowchart of an example of a method for determining a best candidate based on comparing the cumulative additional production rate for each candidate, according to some implementations of the present disclosure.

FIG. 3 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for using a hydrocarbon well performance decline curve as an evaluation tool for production loss. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The techniques of the present disclosure can be used to improve the candidate selection and post-job gain assessment. The techniques can be used to evaluate selected candidates based on the longevity of enhanced performance sustainability before falling back to pre-job oil production rates by translating well performance into cumulative additional production. Calculation methods can focus on a performance decline factor which is averaged based on historical stimulated wells' performance by gathering pre- and post-stimulation job data and calculating the decline factor for each.

The techniques can build upon software used to dynamically model hydrocarbon well skin and candidate selection for performance improvement. The techniques can focus on candidate selection for stimulation operations based on generated profits from post-job additional oil gains. An equation can be used to calculate decline time for all candidates in order to estimate a monthly additional oil production rate. The equation can be based on a decline factor which is calculated using the historical post stimulation jobs' performance and decline period. In some implementations, the following steps can be used in a hydrocarbon well performance decline curve and evaluation.

First, pre- and post-stimulation production rates are identified for the initial stimulation job candidates utilizing a performance evaluation tool (refer to Table 3).

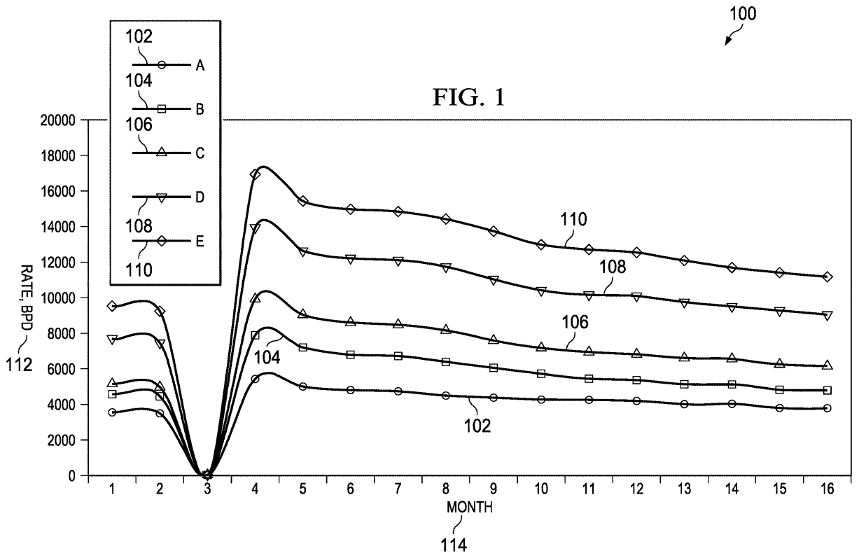

Second, the field performance decline factor is the average slope of the post-job monthly rate change for each well. In some implementation, the following steps can be used for the calculation. Monthly pre- and post-stimulation job data is gathered from performed jobs in the field (refer to Table 1). Wherever flowing wellhead pressure (FWHP) is different, conformance through hydraulic well modeling is obtained to calculate the oil production rate at a constant FWHP. The data for all jobs plotted, and the slope of the pre- and post-job monthly rate changes, are calculated for each well. If needed, the first one or two tests are excluded to insure stable performance drop (refer to FIG. 1), for example, retaining Wells A-E. Outliers, if any, are identified and excluded, as there may be wells which have declined rapidly due to local factors such as water breakthrough, fines migration, and scale build-up. The remaining wells are used to calculate an average slope of field performance decline factor (refer to Table 2).

Third, the following performance decline equation can be used to calculate, for a calculated time period, a future additional production rate gain associated with a stimulated well to reach its pre-stimulation (initial) oil production rate (refer to Table 4):

q_{f}=DF×tₘ+qᵢ (1)

where q_{f} is a future additional production rate gain, DF is a performance decline factor, tₘ is a time (in months), and qᵢ is a post-stimulation initial additional production rate.

Fourth, the equation can be run until q_{f} is close to, but not equal to, zero. The resulting tₘ is the decline time period required to calculate the cumulative oil gain, where qᵢ=post-job initial additional production rate—pre-job production rate.

FIG. 1 is a graph 100 showing examples of plots 102-110 of monthly production rates for five wells, according to some implementations of the present disclosure. The plots 102-110 correspond to Wells A, B, C, D, and E, respectively. The plots 102-110 are plotted relative to a production rate axis 112 (for example, in barrels per day (BPD)) over a monthly time axis 114.

Fifth, a performance decline equation is used to calculate the monthly additional production rate. For example, Equation (1) can be used. Table 5 provides example results.

Sixth, the cumulative additional production rate is calculated and converted to profit for each candidate. Table 6 provides example results.

Seventh, the results are compared for best candidate selection, for example, by selecting the highest monetary value or profit.

To further explain the previously presented steps, the following is a field example used to calculate the profit (for example, in dollars) for different stimulation job candidates.

Monthly pre- and post-stimulation job data is gathered from performed jobs in the field in order to estimate a field performance decline factor. The estimate uses monthly production rates collectively shown in Tables 1A and 1B.

TABLE 1A
Monthly Production Rates

| | | Monthly Rate, BPD | | | | | | | |
|---|---|---|---|---|---|---|---|---|---|
| # | Well | 1 | 2 | 3, 4 | 5 | 6 | 7 | 8 | 9 |
| 1 | A | 3550 | 3500 | 0 | 5500 | 5000 | 4800 | 4750 | 4500 |
| 2 | B | 1050 | 1000 | 0 | 2500 | 2200 | 2000 | 2000 | 1900 |
| 3 | C | 550 | 500 | 0 | 2000 | 1800 | 1800 | 1750 | 1780 |
| 4 | D | 2550 | 2500 | 0 | 4000 | 3650 | 3650 | 3650 | 3600 |
| 5 | E | 1850 | 1800 | 0 | 3000 | 2800 | 2780 | 2750 | 2700 |

TABLE 1B
Monthly Production Rates

| | | Monthly Rate, BPD | | | | | | | |
|---|---|---|---|---|---|---|---|---|---|
| # | Well | 10 | 11 | 12 | 13 | 14 | 15 | 16 | 17 |
| 1 | A | 4400 | 4250 | 4250 | 4200 | 4000 | 4050 | 3800 | 3800 |
| 2 | B | 1680 | 1460 | 1200 | 1200 | 1150 | 1100 | 1050 | 1000 |
| 3 | C | 1500 | 1470 | 1480 | 1450 | 1450 | 1400 | 1400 | 1360 |
| 4 | D | 3480 | 3260 | 3260 | 3300 | 3170 | 3000 | 3050 | 2900 |
| 5 | E | 2700 | 2590 | 2540 | 2420 | 2340 | 2180 | 2150 | 2150 |

The data for all jobs is plotted, and the slope of the pre- and post-job monthly rate changes are calculated for each well.

An example calculation for Well-A slope is given as:

$$Slope = \frac{( Post Job Initial Rate - Latest Rate > Pre Job Rate )}{Δ {t}_{month}} \qquad ( 2 )$$

where Δtₘₒₙₜₕ is a delta time (in months), with value substitutions given as:

$$Slope = \frac{( 5000 - 3800 )}{( 16 - 6 )} = - 120 \qquad ( 3 )$$

The following table illustrates the slope for each well along with the averaged field performance decline factor:

TABLE 2
Slope for Each Well

| # | Well | Slope |
|---|---|---|
| 1 | A | −120 |
| 2 | B | −109 |
| 3 | C | −40 |
| 4 | D | −68 |
| 5 | E | −65 |

| | |
|---|---|
| Field Average Performance Decline Factor | −80 |

Pre- and post-stimulation production rates for the initial candidates are computed:

TABLE 3
Simulated Rates for Each Well

| # | Well | Initial Rate, BPD | Stimulated Rate, BPD |
|---|---|---|---|
| 1 | F | 945 | 2490 |
| 2 | G | 2070 | 4010 |
| 3 | H | 1080 | 1950 |

A time period (for example, in a number of months) is calculated in which a stimulated well will reach its pre-stimulation (initial) oil production rate:

TABLE 4
Declined Additional Production Rates

| | | | | Field | | Declined |
|---|---|---|---|---|---|---|
| | | | | Average | Decline | Additional |
| | | Initial | Stimulated | Decline | Time, | Production |
| # | Well | Rate, BPD | Rate, BPD | Rate | Month | Rate, BPD |
| 1 | F | 945 | 2490 | −80 | 19 | 16 |
| 2 | G | 2070 | 4010 | −80 | 24 | 9 |
| 3 | H | 1080 | 1950 | −80 | 10 | 65 |

In an example of a calculation for Well-F, the equation is run to reach a future rate (q_{f}) equal to or less than the pre-job rate (945 BPD), given as:

q_{f}=DF×tₘ+qᵢ (4)

DF=−80 (5)

tₘ=0→ [symbol] (6)

qᵢ 2490−945=1545 (7)

905=−80×tₘ+1545 (8)

tₘ=19 months (9)

The monthly additional production rate is calculated using the performance decline equation. An example for Well-F for calculating the additional production rate for the second month after the stimulation operation is given as:

q_{f}=DF×tₘ+qᵢ (10)

DF=−80 (11)

tₘ=2 (12)

qᵢ 2490−945=1545 (13)

q_{f}=−80×2+1545 (14)

q_{f}=1384 BPD (15)

The calculation is repeated for each month to reach an additional production rate approaching zero. The following table summarizes the monthly results for the three candidate wells F, G, and H.

TABLE 5
Monthly Additional Production Rates

| | Well F | Well G | Well H |
|---|---|---|---|
| Month | Additional Production Rate, BPD | | |
| 1 | 1545 | 1940 | 870 |
| 2 | 1384 | 1779 | 709 |
| 3 | 1304 | 1699 | 629 |
| 4 | 1223 | 1618 | 548 |
| 5 | 1143 | 1538 | 468 |
| 6 | 1062 | 1457 | 387 |
| 7 | 982 | 1377 | 307 |
| 8 | 901 | 1296 | 226 |
| 9 | 821 | 1216 | 146 |
| 10 | 740 | 1135 | 65 |
| 11 | 660 | 1055 | 0 |
| 12 | 580 | 975 | 0 |
| 13 | 499 | 894 | 0 |
| 14 | 419 | 814 | 0 |
| 15 | 338 | 733 | 0 |
| 16 | 258 | 653 | 0 |
| 17 | 177 | 572 | 0 |
| 18 | 97 | 492 | 0 |
| 19 | 16 | 411 | 0 |
| 20 | 0 | 331 | 0 |
| 21 | 0 | 250 | 0 |
| 22 | 0 | 170 | 0 |
| 23 | 0 | 90 | 0 |

The cumulative additional production rate is calculated for each candidate. First, the total additional production rate per month is calculated, then the results are added to determine the cumulative gain. The result is converted from barrels (bbls) to equivalent millions of dollars ($MM) gained, for example, using an estimated oil price. Table 6 provides example results:

TABLE 6
Equivalent Dollars Gained

| # | Well | Cumulative Additional Production, bbl | $MM Gain |
|---|---|---|---|
| 1 | F | 424,473 | 12.7 |
| 2 | G | 675,123 | 20.3 |
| 3 | H | 130,664 | 3.9 |

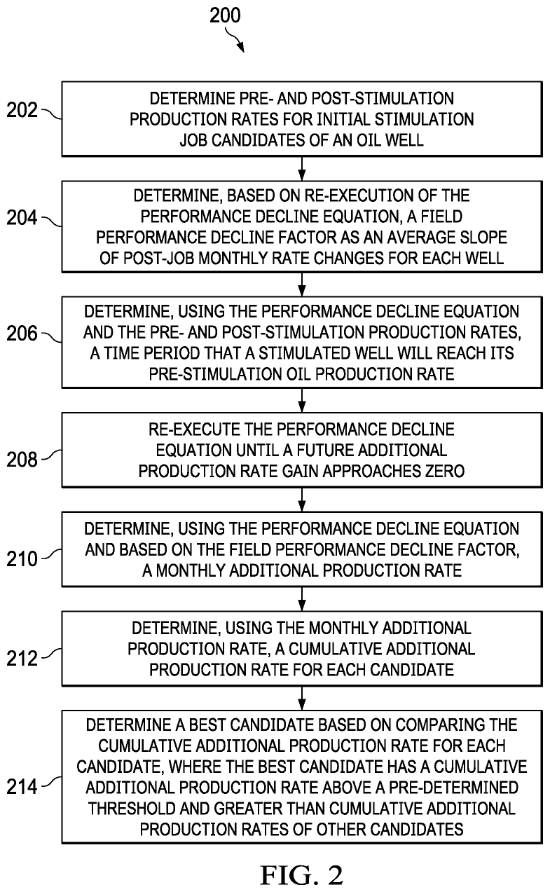

FIG. 2 is a flowchart of an example of a method 200 for determining a best candidate based on comparing the cumulative additional production rate for each candidate, according to some implementations of the present disclosure. For clarity of presentation, the description that follows generally describes method 200 in the context of the other figures in this description. However, it will be understood that method 200 can be performed, for example, by any suitable system, environment, software, and hardware, or a combination of systems, environments, software, and hardware, as appropriate. In some implementations, various steps of method 200 can be run in parallel, in combination, in loops, or in any order.

At 202, pre- and post-stimulation production rates are determined for initial stimulation job candidates of an oil well. Examples of monthly production rates are shown in Tables 1A and 1B. From 202, method 200 proceeds to 204.

At 204, a field performance decline factor is determined as an average slope of post-job monthly rate changes for each well determined based on execution of the performance decline equation. In some implementations, the process can include removing outliers for wells that declined rapidly due to local factors including one or more of water breakthrough, fines migration, and scale build-up. In some implementations, the process can include excluding initial performance months for wells to insure stable performance drop, such as the initial months shown in FIG. 1. From 204, method 200 proceeds to 206.

At 206, a time period that a stimulated well will reach its pre-stimulation oil production rate is determined using the performance decline equation and the pre- and post-stimulation production rates. The performance decline equation that is used can be the performance decline equation given in Equation (1). The post-stimulation initial additional production rate qᵢ used in Equation (1) can be computed as a difference between a post-job initial additional production rate and a pre-job production rate. From 206, method 200 proceeds to 208.

At 208, the performance decline equation is re-executed until a future additional production rate gain approaches zero. For example, Equation (1) can be re-executed. From 208, method 200 proceeds to 210.

At 210, a monthly additional production rate is determined using the performance decline equation and based on the field performance decline factor. Table 5 shows examples of monthly additional production rates that are determined. From 210, method 200 proceeds to 212.

At 212, a cumulative additional production rate for each candidate is determined using the monthly additional production rate. Table 6 shows cumulative additional production rate for each of three wells. From 212, method 200 proceeds to 214.

At 214, a best candidate is determined based on comparing the cumulative additional production rate for each candidate. The best candidate has a cumulative additional production rate above a pre-determined threshold and greater than cumulative additional production rates of other candidates. For example, the well with the highest cumulative additional production rate shown in Table 6 can be selected. After 214, method 200 can stop.

In some implementations, method 200 further includes determining equivalent millions of dollars ($MM) gained using an estimate, in barrels (bbls), of the monthly additional production rate. As an example, monetary gains can be determined and used in decision-making processes for well operations. The last column in Table 6 shows example monetary gains.

In some implementations, method 200 further includes providing a graphical user interface for displaying graphs comparing performance drops of different wells. As an example, graphs such as the graph shown in FIG. 1 can be provided to engineers and managers associated with drilling operations.

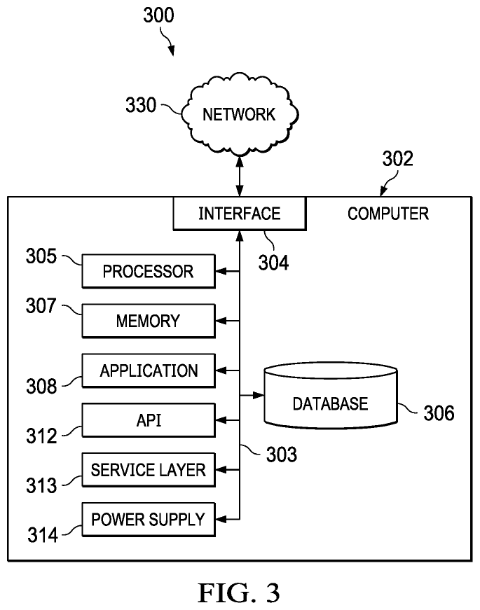

FIG. 3 is a block diagram of an example computer system 300 used to provide computational functionalities associated with described algorithms, methods, functions, processes, flows, and procedures described in the present disclosure, according to some implementations of the present disclosure. The illustrated computer 302 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 302 can include input devices such as keypads, keyboards, and touch screens that can accept user information. Also, the computer 302 can include output devices that can convey information associated with the operation of the computer 302. The information can include digital data, visual data, audio information, or a combination of information. The information can be presented in a graphical user interface (UI) (or GUI).

The computer 302 can serve in a role as a client, a network component, a server, a database, a persistency, or components of a computer system for performing the subject matter described in the present disclosure. The illustrated computer 302 is communicably coupled with a network 330. In some implementations, one or more components of the computer 302 can be configured to operate within different environments, including cloud-computing-based environments, local environments, global environments, and combinations of environments.

At a top level, the computer 302 is an electronic computing device operable to receive, transmit, process, store, and manage data and information associated with the described subject matter. According to some implementations, the computer 302 can also include, or be communicably coupled with, an application server, an email server, a web server, a caching server, a streaming data server, or a combination of servers.

The computer 302 can receive requests over network 330 from a client application (for example, executing on another computer 302). The computer 302 can respond to the received requests by processing the received requests using software applications. Requests can also be sent to the computer 302 from internal users (for example, from a command console), external (or third) parties, automated applications, entities, individuals, systems, and computers.

Each of the components of the computer 302 can communicate using a system bus 303. In some implementations, any or all of the components of the computer 302, including hardware or software components, can interface with each other or the interface 304 (or a combination of both) over the system bus 303. Interfaces can use an application programming interface (API) 312, a service layer 313, or a combination of the API 312 and service layer 313. The API 312 can include specifications for routines, data structures, and object classes. The API 312 can be either computer-language independent or dependent. The API 312 can refer to a complete interface, a single function, or a set of APIs.

The service layer 313 can provide software services to the computer 302 and other components (whether illustrated or not) that are communicably coupled to the computer 302. The functionality of the computer 302 can be accessible for all service consumers using this service layer. Software services, such as those provided by the service layer 313, can provide reusable, defined functionalities through a defined interface. For example, the interface can be software written in JAVA, C++, or a language providing data in extensible markup language (XML) format. While illustrated as an integrated component of the computer 302, in alternative implementations, the API 312 or the service layer 313 can be stand-alone components in relation to other components of the computer 302 and other components communicably coupled to the computer 302. Moreover, any or all parts of the API 312 or the service layer 313 can be implemented as child or sub-modules of another software module, enterprise application, or hardware module without departing from the scope of the present disclosure.

The computer 302 includes an interface 304. Although illustrated as a single interface 304 in FIG. 3, two or more interfaces 304 can be used according to particular needs, desires, or particular implementations of the computer 302 and the described functionality. The interface 304 can be used by the computer 302 for communicating with other systems that are connected to the network 330 (whether illustrated or not) in a distributed environment. Generally, the interface 304 can include, or be implemented using, logic encoded in software or hardware (or a combination of software and hardware) operable to communicate with the network 330. More specifically, the interface 304 can include software supporting one or more communication protocols associated with communications. As such, the network 330 or the interface's hardware can be operable to communicate physical signals within and outside of the illustrated computer 302.

The computer 302 includes a processor 305. Although illustrated as a single processor 305 in FIG. 3, two or more processors 305 can be used according to particular needs, desires, or particular implementations of the computer 302 and the described functionality. Generally, the processor 305 can execute instructions and can manipulate data to perform the operations of the computer 302, including operations using algorithms, methods, functions, processes, flows, and procedures as described in the present disclosure.

The computer 302 also includes a database 306 that can hold data for the computer 302 and other components connected to the network 330 (whether illustrated or not). For example, database 306 can be an in-memory, conventional, or a database storing data consistent with the present disclosure. In some implementations, database 306 can be a combination of two or more different database types (for example, hybrid in-memory and conventional databases) according to particular needs, desires, or particular implementations of the computer 302 and the described functionality. Although illustrated as a single database 306 in FIG. 3, two or more databases (of the same, different, or combination of types) can be used according to particular needs, desires, or particular implementations of the computer 302 and the described functionality. While database 306 is illustrated as an internal component of the computer 302, in alternative implementations, database 306 can be external to the computer 302.

The computer 302 also includes a memory 307 that can hold data for the computer 302 or a combination of components connected to the network 330 (whether illustrated or not). Memory 307 can store any data consistent with the present disclosure. In some implementations, memory 307 can be a combination of two or more different types of memory (for example, a combination of semiconductor and magnetic storage) according to particular needs, desires, or particular implementations of the computer 302 and the described functionality. Although illustrated as a single memory 307 in FIG. 3, two or more memories 307 (of the same, different, or combination of types) can be used according to particular needs, desires, or particular implementations of the computer 302 and the described functionality. While memory 307 is illustrated as an internal component of the computer 302, in alternative implementations, memory 307 can be external to the computer 302.

The application 308 can be an algorithmic software engine providing functionality according to particular needs, desires, or particular implementations of the computer 302 and the described functionality. For example, application 308 can serve as one or more components, modules, or applications. Further, although illustrated as a single application 308, the application 308 can be implemented as multiple applications 308 on the computer 302. In addition, although illustrated as internal to the computer 302, in alternative implementations, the application 308 can be external to the computer 302.

The computer 302 can also include a power supply 314. The power supply 314 can include a rechargeable or non-rechargeable battery that can be configured to be either user- or non-user-replaceable. In some implementations, the power supply 314 can include power-conversion and management circuits, including recharging, standby, and power management functionalities. In some implementations, the power-supply 314 can include a power plug to allow the computer 302 to be plugged into a wall socket or a power source to, for example, power the computer 302 or recharge a rechargeable battery.

There can be any number of computers 302 associated with, or external to, a computer system containing computer 302, with each computer 302 communicating over network 330. Further, the terms “client,” “user,” and other appropriate terminology can be used interchangeably, as appropriate, without departing from the scope of the present disclosure. Moreover, the present disclosure contemplates that many users can use one computer 302 and one user can use multiple computers 302.

Described implementations of the subject matter can include one or more features, alone or in combination.

For example, in a first implementation, a computer-implemented method includes the following. Pre- and post-stimulation production rates are determined for initial stimulation job candidates of an oil well. A field performance decline factor is determined as an average slope of post-job monthly rate changes for each well determined based on execution of the performance decline equation. A time period that a stimulated well will reach its pre-stimulation oil production rate is determined using the performance decline equation and the pre- and post-stimulation production rates. The performance decline equation is re-executed until a future additional production rate gain approaches zero. A monthly additional production rate is determined using the performance decline equation and based on the field performance decline factor. A cumulative additional production rate for each candidate is determined using the monthly additional production rate. A best candidate is determined based on comparing the cumulative additional production rate for each candidate. The best candidate has a cumulative additional production rate above a pre-determined threshold and greater than cumulative additional production rates of other candidates.

The foregoing and other described implementations can each, optionally, include one or more of the following features:

A first feature, combinable with any of the following features, where the performance decline equation is given by: q_{f}=DF×tₘ+qᵢ, where q_{f} is a future additional production rate gain, DF is a performance decline factor, tₘ is a time (in months), and qᵢ is a post-stimulation initial additional production rate.

A second feature, combinable with any of the previous or following features, where the post-stimulation initial additional production rate is computed as a difference between a post-job initial additional production rate and a pre-job production rate.

A third feature, combinable with any of the previous or following features, where the method further includes determining equivalent millions of dollars ($MM) gained using an estimate, in barrels (bbls), of the monthly additional production rate.

A fourth feature, combinable with any of the previous or following features, where the method further includes removing outliers for wells that declined rapidly due to local factors including one or more of water breakthrough, fines migration, and scale build-up.

A fifth feature, combinable with any of the previous or following features, where the method further includes excluding initial performance months for wells to insure stable performance drop.

A sixth feature, combinable with any of the previous or following features, where the method further includes providing a graphical user interface for displaying graphs comparing performance drops of different wells.

In a second implementation, a non-transitory, computer-readable medium stores one or more instructions executable by a computer system to perform operations including the following. Pre- and post-stimulation production rates are determined for initial stimulation job candidates of an oil well. A field performance decline factor is determined as an average slope of post-job monthly rate changes for each well determined based on execution of the performance decline equation. A time period that a stimulated well will reach its pre-stimulation oil production rate is determined using the performance decline equation and the pre- and post-stimulation production rates. The performance decline equation is re-executed until a future additional production rate gain approaches zero. A monthly additional production rate is determined using the performance decline equation and based on the field performance decline factor. A cumulative additional production rate for each candidate is determined using the monthly additional production rate. A best candidate is determined based on comparing the cumulative additional production rate for each candidate. The best candidate has a cumulative additional production rate above a pre-determined threshold and greater than cumulative additional production rates of other candidates.

The foregoing and other described implementations can each, optionally, include one or more of the following features:

A first feature, combinable with any of the following features, where the performance decline equation is given by: q_{f}=DF×tₘ+qᵢ, where q_{f} is a future additional production rate gain, DF is a performance decline factor, tₘ is a time (in months), and qᵢ is a post-stimulation initial additional production rate.

A second feature, combinable with any of the previous or following features, where the post-stimulation initial additional production rate is computed as a difference between a post-job initial additional production rate and a pre-job production rate.

A third feature, combinable with any of the previous or following features, where the operations further include determining equivalent millions of dollars ($MM) gained using an estimate, in barrels (bbls), of the monthly additional production rate.

A fourth feature, combinable with any of the previous or following features, where the operations further include removing outliers for wells that declined rapidly due to local factors including one or more of water breakthrough, fines migration, and scale build-up.

A fifth feature, combinable with any of the previous or following features, where the operations further include excluding initial performance months for wells to insure stable performance drop.

A sixth feature, combinable with any of the previous or following features, where the operations further include providing a graphical user interface for displaying graphs comparing performance drops of different wells.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. Pre- and post-stimulation production rates are determined for initial stimulation job candidates of an oil well. A field performance decline factor is determined as an average slope of post-job monthly rate changes for each well determined based on execution of the performance decline equation. A time period that a stimulated well will reach its pre-stimulation oil production rate is determined using the performance decline equation and the pre- and post-stimulation production rates. The performance decline equation is re-executed until a future additional production rate gain approaches zero. A monthly additional production rate is determined using the performance decline equation and based on the field performance decline factor. A cumulative additional production rate for each candidate is determined using the monthly additional production rate. A best candidate is determined based on comparing the cumulative additional production rate for each candidate. The best candidate has a cumulative additional production rate above a pre-determined threshold and greater than cumulative additional production rates of other candidates.

The foregoing and other described implementations can each, optionally, include one or more of the following features:

A first feature, combinable with any of the following features, where the performance decline equation is given by: q_{f}=DF×tₘ+qᵢ, where q_{f} is a future additional production rate gain, DF is a performance decline factor, tₘ is a time (in months), and qᵢ is a post-stimulation initial additional production rate.

A second feature, combinable with any of the previous or following features, where the post-stimulation initial additional production rate is computed as a difference between a post-job initial additional production rate and a pre-job production rate.

A third feature, combinable with any of the previous or following features, where the operations further include determining equivalent millions of dollars ($MM) gained using an estimate, in barrels (bbls), of the monthly additional production rate.

A fourth feature, combinable with any of the previous or following features, where the operations further include removing outliers for wells that declined rapidly due to local factors including one or more of water breakthrough, fines migration, and scale build-up.

A fifth feature, combinable with any of the previous or following features, where the operations further include excluding initial performance months for wells to insure stable performance drop.

A sixth feature, combinable with any of the previous or following features, where the operations further include providing a graphical user interface for displaying graphs comparing performance drops of different wells.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
determining pre- and post-stimulation production rates for initial stimulation job candidates of an oil well;
determining, based on execution of a performance decline equation, a field performance decline factor as an average slope of post-job monthly rate changes for each well;
determining, using the performance decline equation and the pre- and post-stimulation production rates, a time period that a stimulated well will reach its pre-stimulation oil production rate;
re-executing the performance decline equation until a future additional production rate gain approaches zero;
determining, using the performance decline equation and based on the field performance decline factor, a monthly additional production rate;
determining, using the monthly additional production rate, a cumulative additional production rate for each candidate; and
determining a best candidate based on comparing the cumulative additional production rate for each candidate, wherein the best candidate has a cumulative additional production rate above a pre-determined threshold and greater than cumulative additional production rates of other candidates.

2. The computer-implemented method of claim 1, wherein the performance decline equation is given by:
q_{f}=DF×tₘ+qᵢ
where q_{f} is a future additional production rate gain, DF is a performance decline factor, tₘ is a time (in months), and qᵢ is a post-stimulation initial additional production rate.

3. The computer-implemented method of claim 2, wherein the post-stimulation initial additional production rate is computed as a difference between a post-job initial additional production rate and a pre-job production rate.

4. The computer-implemented method of claim 1, further comprising:
determining equivalent millions of dollars ($MM) gained using an estimate, in barrels (bbls), of the monthly additional production rate.

5. The computer-implemented method of claim 1, further comprising:
removing outliers for wells that declined rapidly due to local factors including one or more of water breakthrough, fines migration, and scale build-up.

6. The computer-implemented method of claim 1, further comprising:
excluding initial performance months for wells to insure stable performance drop.

7. The computer-implemented method of claim 1, further comprising:
providing a graphical user interface for displaying graphs comparing performance drops of different wells.

8. A computer-implemented system, comprising:
a production rates data store identifying production rates for wells over time;
an equations data store storing containing equations used to determine performance declines associated with production of wells and to predict production of candidate wells;
one or more processors; and
a non-transitory computer-readable storage medium coupled to the one or more processors and storing programming instructions for execution by the one or more processors, the programming instructions instructing the one or more processors to perform operations comprising:
determining pre- and post-stimulation production rates for initial stimulation job candidates of an oil well;
determining, based on execution of a performance decline equation, a field performance decline factor as an average slope of post-job monthly rate changes for each well;
determining, using the performance decline equation and the pre- and post-stimulation production rates, a time period that a stimulated well will reach its pre-stimulation oil production rate;
re-executing the performance decline equation until a future additional production rate gain approaches zero;
determining, using the performance decline equation and based on the field performance decline factor, a monthly additional production rate;
determining, using the monthly additional production rate, a cumulative additional production rate for each candidate; and
determining a best candidate based on comparing the cumulative additional production rate for each candidate, wherein the best candidate has a cumulative additional production rate above a pre-determined threshold and greater than cumulative additional production rates of other candidates.

9. The computer-implemented system of claim 8, wherein the performance decline equation is given by:
q_{f}=DF×tₘ+qᵢ
where q_{f} is a future additional production rate gain, DF is a performance decline factor, tₘ is a time (in months), and qᵢ is a post-stimulation initial additional production rate.

10. The computer-implemented system of claim 9, wherein the post-stimulation initial additional production rate is computed as a difference between a post-job initial additional production rate and a pre-job production rate.

11. The computer-implemented system of claim 8, the operations further comprising:
determining equivalent millions of dollars ($MM) gained using an estimate, in barrels (bbls), of the monthly additional production rate.

12. The computer-implemented system of claim 8, the operations further comprising:
removing outliers for wells that declined rapidly due to local factors including one or more of water breakthrough, fines migration, and scale build-up.

13. The computer-implemented system of claim 8, the operations further comprising:
excluding initial performance months for wells to insure stable performance drop.

14. The computer-implemented system of claim 8, the operations further comprising:
providing a graphical user interface for displaying graphs comparing performance drops of different wells.

15. A non-transitory, computer-readable medium storing one or more instructions executable by a computer system to perform operations comprising:
determining pre- and post-stimulation production rates for initial stimulation job candidates of an oil well;
determining, based on execution of a performance decline equation, a field performance decline factor as an average slope of post-job monthly rate changes for each well;
determining, using the performance decline equation and the pre- and post-stimulation production rates, a time period that a stimulated well will reach its pre-stimulation oil production rate;
re-executing the performance decline equation until a future additional production rate gain approaches zero;
determining, using the performance decline equation and based on the field performance decline factor, a monthly additional production rate;
determining, using the monthly additional production rate, a cumulative additional production rate for each candidate; and
determining a best candidate based on comparing the cumulative additional production rate for each candidate, wherein the best candidate has a cumulative additional production rate above a pre-determined threshold and greater than cumulative additional production rates of other candidates.

16. The non-transitory, computer-readable medium of claim 15, wherein the performance decline equation is given by:
q_{f}=DF×tₘ+qᵢ
where q_{f} is a future additional production rate gain, DF is a performance decline factor, tₘ is a time (in months), and qᵢ is a post-stimulation initial additional production rate.

17. The non-transitory, computer-readable medium of claim 16, wherein the post-stimulation initial additional production rate is computed as a difference between a post-job initial additional production rate and a pre-job production rate.

18. The non-transitory, computer-readable medium of claim 15, the operations further comprising:
determining equivalent millions of dollars ($MM) gained using an estimate, in barrels (bbls), of the monthly additional production rate.

19. The non-transitory, computer-readable medium of claim 15, the operations further comprising:
removing outliers for wells that declined rapidly due to local factors including one or more of water breakthrough, fines migration, and scale build-up.

20. The non-transitory, computer-readable medium of claim 15, the operations further comprising:
excluding initial performance months for wells to insure stable performance drop.
